(19) United States
(12) Patent Application Publication
(10) Pub. No.: US 2015/0018449 A1
(43) Pub. Date: Jan. 15, 2015

(54) METHOD FOR PRODUCING RUBBER MASTER BATCH

(71) Applicant: TOYO TIRE & RUBBER CO., LTD., Osaka (JP)

(72) Inventor: Shinya Hasegawa, Osaka-shi (JP)

(73) Assignee: TOYO TIRE & RUBBER CO., LTD., Osaka (JP)

(21) Appl. No.: 14/219,509

(22) Filed: Mar. 19, 2014

(30) Foreign Application Priority Data
Jul. 12, 2013 (JP) 2013-146271

(51) Int. Cl. C08J 3/22; C08K 13/02

(52) U.S. Cl. CPC C08J 3/22; C08K 13/02
USPC 523/156

(57) ABSTRACT

A method for producing a rubber master batch, comprising: blending, into a diene rubber, 0.1 to 0.5 parts by mass of a peptizing agent, 0.1 to 5.0 parts by mass of a dihydrazide compound, and 10 to 35 parts by mass of a carbon black simultaneously for 100 parts by mass of the diene rubber, and kneading the resultant blend.

### BACKGROUND OF THE INVENTION

1. Field of the Invention

The present invention relates to a method for producing a rubber master batch. This rubber master batch is useful as a raw material of a rubber composition low in thermogenic performance.

2. Description of the Related Art

In recent years, developments of fuel-efficient tires have been actively made in the tire industry from the viewpoint of energy saving. It is said that for the fuel-efficient tire developments, it is indispensable to improve, in particular, the low thermogenic performance of rubber regions of tire treads that are obtained by vulcanization.

As a technique for improving a vulcanized rubber in low thermogenic performance, Patent Document 1 listed below describes a technique of blending a hydrazide compound and a reinforcing filler into a rubber composition as a raw material.

Patent Document 2 listed below describes a technique that is a method of kneading a rubber composition containing a raw material polymer, a hydrazide compound and a carbon black, the method being a method in which the raw material polymer and the hydrazide compound are earlier kneaded, and then the carbon black is added thereto to knead the resultant mixture.

Patent Document 3 listed below describes a technique of using, for a tire tread region of a pneumatic tire, a rubber composition in which 0.05 to 5 parts by mass of a specific hydrazide compound are blended into 100 parts by mass of a rubber component.

### PRIOR ART DOCUMENTS

### Patent Documents

Patent Document 1: JP-B-7-57828

Patent Document 2: JP-A-8-27315

Patent Document 3: JP-A-10-330549

### SUMMARY OF THE INVENTION

However, the present inventors have made eager investigations to find out that the above-mentioned precedent techniques have problems described below. Specifically, according to the technique described in Patent Document 1, the rubber composition tends to be deteriorated in workability, and further a vulcanized rubber obtained therefrom is insufficient in being improved in low thermogenic performance.

In the technique described in Patent Document 2, without performing simultaneous kneading of a raw material polymer, a hydrazide compound and a carbon black, the carbon black is afterward blended into the others, whereby in reaction of the polymer with the hydrazide compound, this compound is caused to react preferentially with the polymer without causing the polymer and the carbon black to compete with each other. However, the resultant rubber composition tends to be still deteriorated in workability. There also remains a room for a further improvement in the low thermogenic performance of a vulcanized rubber yielded from the composition.

In the technique described in Patent document 3, a specific hydrazide compound is used so that disadvantages are produced from the viewpoint of costs. There also remains a room for a further improvement in the workability of the rubber composition, and the low thermogenic performance of a vulcanized rubber yielded from the composition.

In light of the above-mentioned actual situation, the present invention has been made. An object thereof is to provide a method for producing a rubber master batch usable as a raw material of a rubber composition that is improved in workability and is further capable of improving the low thermogenic performance of a vulcanized rubber yielded from the composition. Another object of the invention is to provide a rubber composition for tire treads, a method for producing the composition, and further a pneumatic tire having a tire tread that has a low thermogenic performance and is excellent in fuel-efficient performance.

In order to solve the above-mentioned problems, the inventors have made eager investigations about methods for producing a rubber master batch usable as a raw material of a rubber composition for tire treads, in particular, a mechanism of reaction of a dihydrazide compound with a diene rubber polymer and a carbon black in these methods. As a result, the inventors have found out that by causing the diene rubber polymer, the dihydrazide compound and the carbon black to react with each other in the presence of a peptizing agent, the resultant rubber master batch and a rubber composition about which this rubber master batch is used as a raw material can be restrained from being raised in viscosity and further a vulcanized rubber yielded from this rubber composition can be improved in low thermogenic performance. On the basis of this finding, the present invention has been achieved.

Accordingly, the invention is as follows: a method for producing a rubber master batch, including: blending, into a diene rubber, 0.1 to 0.5 parts by mass of a peptizing agent, 0.1 to 5.0 parts by mass of a dihydrazide compound, and 10 to 35 parts by mass of a carbon black simultaneously for 100 parts by mass of the diene rubber, and kneading the resultant blend.

In this rubber master batch producing method, at the time of blending and kneading the individual components, radicals originating from the peptizing agent promote the generation of polymer radicals in the diene rubber. The polymer radicals react rapidly with the dihydrazide compound. When the carbon black is present in this reaction, bonds between the polymer in the diene rubber and the carbon black are efficiently produced through the dihydrazide compound as a medium, so that the carbon black becomes very good in dispersibility. As a result, the resultant rubber master batch and a rubber composition about which this rubber master batch is used as a raw material can be restrained from being raised in viscosity. Thus, the workability thereof is improved, and simultaneously a vulcanized rubber yielded from this rubber composition can be improved in low thermogenic performance.

As described above, in the rubber master batch producing method according to the present invention, it is important to blend the peptizing agent, the dihydrazide compound, and the carbon black with each other and knead the blend in the state that the three coexist. The invention is clearly distinguished from the techniques described in the prior art documents, which are each a technique of kneading a raw material polymer and a hydrazide compound earlier, and subsequently adding thereto a carbon black and kneading these components. In the invention, the word “simultaneously” means not only that the three of the peptizing agent, the dihydrazide compound and the carbon black are blended into the diene rubber at the very same timing, but also that an initially adding component of the three is blended into the diene rubber, and then a finally adding component thereof is blended with the already-obtained blend within one minute of the initial blending. The initially adding component is blended into the diene rubber, and then the finally adding component is blended with the already-obtained blend preferably within 45 seconds of the initial blending, more preferably within 30 seconds thereof. Even more preferably, the three are substantially simultaneously blended. When the respective blending timings of the peptizing agent, the dihydrazide compound and the carbon black have an interval between any two of the timings, it is preferred to blend the carbon black initially into the diene rubber.

The invention also relates to a method for producing a rubber composition for tire treads, including step I of producing a rubber master batch by the above-mentioned rubber master batch producing method, step II of blending, into the rubber master batch, one or more blending agents different from any vulcanization-related blending agent, and kneading the resultant blend, and step III of blending, after step II, one or more vulcanization-related blending agents into the blend obtained through step II, and kneading the resultant blend; and a rubber composition for tire treads, which is obtained by this producing method. The rubber master batch is restrained from being raised in viscosity, and further the carbon black therein is excellent in dispersibility; thus, this rubber composition producing method makes it possible to produce a rubber composition that is also restrained from being raised in viscosity and is further excellent in the dispersibility of the carbon black therein.

Furthermore, the invention relates to a pneumatic tire obtained by use of the above-mentioned rubber composition for tire treads. The pneumatic tire, which has a tire tread obtained using, as a raw material, the rubber composition for tire treads, has low thermogenic performance to be improved very much in fuel-efficient performance.

### DETAILED DESCRIPTION OF THE PREFERRED EMBODIMENTS

In the rubber master batch producing method according to the present invention, which is equivalent to “step I”, a peptizing agent, a dihydrazide compound, and a carbon black are simultaneously blended into a diene rubber, and the resultant blend is kneaded.

In this rubber master batch producing method according to the invention, and the method according to the invention for producing a rubber composition for tire treads, a mixer or disperser is used. This mixer or disperser may be, for example, a gear-engaging type Banbury mixer, a tangential line type Banbury mixer, or a kneader. In particular, a gear-engaging type Banbury mixer is preferred.

Examples of the diene rubber include natural rubber (NR), polyisoprene rubber (IR), polystyrene butadiene rubber (SBR), polybutadiene rubber (BR), chloroprene rubber (CR), and nitrile rubber (NBR). As the need arises, the following is preferably usable: such a rubber in which one or more terminals are modified (such as terminal-modified BR or terminal-modified SBR), or a rubber in which modification is attained to give a desired property to a rubber as described above (such as modified NR). The species of the polybutadiene rubber (BR) may be a species synthesized, using a cobalt (Co), neodymium (Nd), nickel (Ni), titanium (Ti) or lithium (Li) catalyst; a species synthesized, using a polymerization catalyst composition containing a metallocene complex described in WO 2007-129670; or a polybutadiene rubber species containing syndiotactic crystal.

When the low thermogenic performance of a vulcanized rubber to be obtained is considered, the species of the polystyrene butadiene rubber is in particular preferably a species in which the styrene content by percentage is from 10 to 40% by mass, the vinyl bond content by percentage in its butadiene moieties is from 10 to 70% by mass, and the content by percentage of its cis isomers is 10% or more by mass. The species is in particular preferably a species in which the styrene content by percentage is from 15 to 25% by mass, the vinyl bond content by percentage in its butadiene moieties is from 10 to 60% by mass, and the content by percentage of its cis isomers is 20% or more by mass. When the vulcanized rubber is used for a tread rubber region of a pneumatic tire, it is more preferred to use a polystyrene butadiene rubber species of a non-oil-added type than of an oil-added type.

In the invention, the diene rubber is preferably natural rubber (NR). When the total amount of the diene rubber is regarded as 100 parts by mass, the amount of the natural rubber contained therein is preferably 50 parts or more by mass, more preferably 75% or more by mass, in particular preferably about 100 parts by mass.

The peptizing agent may be called a mastication promoter or peptizer. The peptizing agent is a blending agent used for the following: when the peptizing agent is masticated in the state of being blended into a rubber component, the agent generates radicals to generate polymer radicals in the rubber component to effectively cause a cleavage reaction of polymer main chains in the rubber component. In the invention, examples of the peptizing agent include o,o-dibenzamidediphenyl disulfide, a zinc salt of 2-benzamidethiophenol, 2-thionaphthol, thioxylenol, pentachlorothiophenol, and other disulfides and mercaptans; substances each obtained by adding a metal catalyst to any one of these examples; 2-mercaptobenzothiazole, and other thiazoles; benzoyl peroxide and other diacyl peroxides; dicumyl peroxide and other dialkyl peroxides; and other organic peroxides. Other examples thereof include xylenethiol, pentachlorothiophenol, a zinc salt of petachlorothiophenol, 4-tert-butyl-o-thiocresol, a zinc slat of 4-tert-butyl-o-thiocresol, a dixylyl/disulfide mixture, zinc thiobenzoate, dibenzamidethiophenyl disulfide, a dibenzamidethiophenyl disulfide/stearic acid mixture, alkylatedphenol/sulfide, aromatic sulfur-containing compounds, organic complex compounds, dinitroso/resorcinol, and high-molecular-weight oil-soluble sulfonic acids. Additional examples thereof include piperidine pentamethylenedithiocarbamate, and a dibenzamidediphenyl disulfide/stearic acid mixture. A compound known as a vulcanization promoter may be used, examples thereof including a cyclohexylamine salt of 2-merpcaptobenzothioazole, N-cyclohexyl-2-benzothiazolylsulfenamide, and N-phenyl-N′-isopropyl-p-phenylenediamine. Especial examples of the peptizing agent are compounds each obtained by incorporating a reactive functional group such as a hydroxyl or carboxyl group into the molecule of any one of the above-mentioned peptizing agents (hereinafter, the compounds are called “functional-group-introduced peptizing agents”). These functional-group-introduced peptizing agents maybe used alone, or may each be used in a combination with one or more of the above-mentioned ordinary peptizing agents in which the blend ratio between these components is an arbitrary ratio. When such a functional-group-introduced peptizing agent is used to masticate natural rubber, the reactive functional groups can be introduced into molecular chains of the natural rubber. Examples of hydroxyl-group-containing one of the functional-group-introduced peptizing agents include 2-hydroxydiphenyl disulfide, 2-hydroxyethyl disulfide, mercaptophenol, 2-merpcatoethanol, and 3-mercapto-1,2-propanediol. Examples of carboxyl-group-containing one of the agents include mercaptobenzoic acid, mercaptoacetic acid, and mercaptopropionic acid. A carboxylic anhydride such as maleic anhydride is usable as one of the functional-group-introduced peptizing agents. When the carboxylic anhydride such as maleic anhydride is used in a combination with one or more of the above-mentionedpeptizing agents in which the blend ratio between these components is an arbitrary ratio, carboxylic anhydride groups can be introduced into molecular chains of natural rubber.

In the rubber master batch producing method according to the invention, 0.1 to 0.5 parts by mass of the peptizing agent is blended into 100 parts by mass of the diene rubber. The blend amount of the peptizing agent is preferably from 0.1 to 0.3 parts by mass.

The dihydrazide compound is a compound having, in the molecule thereof, two hydrazide groups (—CONHNH₂). Examples thereof include dihydrazide isophthalate, dihydrazide terephthalate, dihydrazide azelate, dihydrazide adipate, dihydrazide succinate, dihydrazide dieicosanoate, and 7,11-octadecadiene-1,18-dicarbohydrazide. Of these compounds, dihydrazide isophthalate and dihydrazide adipate are preferred in the invention.

In the rubber master batch producing method according to the invention, the dihydrazide compound is blended in an amount preferably from 0.1 to 5.0 parts by mass, more preferably from 0.2 to 2.0 parts by mass for 100 parts by mass of the diene rubber.

The carbon black may be any carbon black species usable in ordinary rubber industries, such as SAF, ISAF, HAF, FEF or GPF, or may be any electroconductive carbon black species such as acetylene black or Ketjen black.

In the rubber master batch producing method according to the invention, the carbon black is blended in an amount preferably from 10 to 35 parts by mass, more preferably from 15 to 30 parts by mass for 100 parts by mass of the diene rubber.

In the rubber master batch producing method according to the invention, the peptizing agent, the dihydrazide compound, and the carbon black are simultaneously blended into the diene rubber, and the blend is kneaded. In order to heighten the reaction rate among the diene rubber, the dihydrazide compound, and the carbon black while the resultant rubber is prevented from undergoing deteriorations such as rubber scorch, the blending/kneading temperature is set into a range preferably from 120 to 170° C., more preferably from 130 to 160° C. From the same viewpoint, after the addition of the three of the peptizing agent, the dihydrazide compound and the carbon black, the kneading period is set into a range preferably from 1 to 10 minutes, more preferably from 1 to 5 minutes.

In the rubber composition producing method according to the invention, one or more blending agents different from any vulcanization-related blending agent are blended into the rubber master batch obtained in step I, and the resultant blend is kneaded (step II). Examples of the blending agent(s) different from the vulcanization-related blending agent include an additional rubber, a carbon black, silica, a silane coupling agent, an anti-aging agent, zinc oxide, a softening agent such as stearic acid, wax or oil, a processing aid, an organic acid metal salt, a methylene acceptor, and a methylene donor. Preferably, in step II, the blending/kneading temperature is from 145 to 170° C., and the kneading period is from about 1 to 10 minutes.

Examples of the organic acid metal salt include cobalt naphthenate, cobalt stearate, cobalt borate, cobalt oleate, cobalt maleate, and cobalt borate trineodecanoate.

The methylene acceptor may be a phenolic compound, or a phenolic resin, in which a phenolic compound is condensed with formaldehyde. Examples of the phenolic compound include phenol and resorcin; respective alkyl derivatives thereof; and respective alkyl derivatives of other phenolic compounds. Examples of the alkyl derivatives include methyl derivatives of cresol or xylenol; and respective long-chain alkyl derivatives of phenolic compounds, such as nonylphenol and octylphenol. The phenolic compound may be a phenolic compound having, as its substituent, an acyl group such as an acetyl group.

Examples of the phenolic resin, in which a phenolic compound is condensed with formaldehyde, include resorcin-formaldehyde resin, phenolic resin (phenol-formaldehyde resin), cresol resin (cresol-formaldehyde resin), and formaldehyde resins each made from plural phenolic compounds. These are each used in the form of an uncured resin having fluidity or thermal fluidity.

Of these methylene receptors, resorcin or a resorcin derivative is preferred from the viewpoint of the compatibility thereof with the rubber component or other components, the density of a resin obtained after the curing thereof, and the reliability. Particularly preferred is resorcin or resorcin-alkylphenol-formalin resin.

The methylene donor may be hexamethylenetetramine or a melamine resin. Examples of the melamine resin include methylolmelamine, a partially etherized product of methylolmelamine, and condensates each made from melamine, formaldehyde, and methanol. Of these methylene donors, particularly preferred is hexamethoxymethylmelamine.

As the additional rubber, a diene rubber usable for the production of a rubber master batch maybe used in the same manner.

The anti-aging agent may be any anti-aging agent usable ordinarily for rubbers. Examples thereof include aromatic amine type, amine-ketone type, monophenolic type, bisphenolic type, polyphenolic type, dithiocarbamic acid salt type, and thiourea type anti-aging agents. These may be used alone or in the form of an appropriate mixture. The content of the anti-aging agent(s) is preferably from 0.0 to 5.0 parts by mass, more preferably from 0.5 to 3.0 parts by mass for 100 parts by mass of the rubber component(s).

After step II, one or more vulcanization-related blending agents are blended, and the resultant blend is kneaded (step III). Examples of the vulcanization-related blending agent(s) used in step III include vulcanizers such as sulfur and organic peroxides, vulcanization promoters, vulcanization promoting aids, and vulcanization retarders. The blending/kneading temperature in step III is selectable at will in accordance with the blend, and the kneading period therein is preferably from about 1 to 10 minutes.

It is sufficient for the sulfur vulcanizers that their sulfur species is a sulfur species for ordinary rubbers. Examples thereof include powdery sulfur, precipitated sulfur, insoluble sulfur, and highly dispersed sulfur. Considering physical properties, the endurance and others of the rubber component(s) after it/they is/are vulcanized, the amount of used one(s) of the sulfur vulcanizers is preferably from 0.5 to 5.0 parts by mass for 100 parts by mass of the rubber component(s) in terms of the amount of sulfur.

The vulcanization promoters may each be a vulcanization promoter usable usually for rubber vulcanization, and examples thereof include sulfenamide type, thiuram type, thiazole type, thiourea type, guanidine type, and dithiocarbamic acid salt type vulcanization promoters. These may be used alone or in the form of an appropriate mixture. The blend amount of used one(s) of the vulcanization promoters is preferably from 0.1 to 5.0 parts by mass for 100 parts by mass of the rubber component(s).

### EXAMPLES

Hereinafter, a description will be made about examples demonstrating the subject matter and the advantageous effects of the present invention, and others. About items for evaluating a rubber composition of each of the examples and the others, the following was evaluated on the basis of evaluating-methods described below: a rubber sample obtained by heating the rubber composition at 150° C. for 30 minutes to be vulcanized.

### (1) Tan δ (Low Thermogenic Performance)

A viscoelastic spectrometer manufactured by a company, UBM, is used to measure the tan δ of the sample at an initial strain of 15%, a dynamic strain of ±2.5%, a frequency of 10 Hz and a temperature of 60° C. The low thermogenic performance thereof is evaluated on the basis of the tan δ value. The evaluation is made by regarding the value of Comparative Example 1 as 100, and obtaining an index of the sample to be evaluated, which is relative to the value of Comparative Example 1. As the resultant numerical value is smaller, the sample is better in low thermogenic performance.

### (2) Workability

According to JIS K6300, the ML (1+4) of the sample is measured at a measuring temperature of 100° C. under conditions that the pre-heating period is 1 minute and the rotor operating period is 4 minutes. The evaluation is made by regarding the value of Comparative Example 1 as 100, and obtaining an index of the sample to be evaluated. As the resultant numerical value is smaller, the sample is better in workability.

(Rubber Composition Preparation)

A rubber component and blending agents for each of Examples 1 to 4 and Comparative Examples 1 to 8 were blended with each other in accordance with a blend formulation shown in Table 1. An ordinary Banbury mixer was used to knead the resultant blend to prepare a rubber composition. At the stage of producing a master batch of the rubber composition, the rubber component was kneaded while a or no carbon black, a or no peptizing agent, and a dihydrazide compound (as one or some of the blending agents) used in the example were substantially simultaneously blended into the rubber component. However, in Comparative Example 7, without producing any master batch in step I, the rubber component and the blending agents were blended with each other and kneaded in step II. Details of each of the rubber component and the blending agents shown in Table 1 are described below (in Table 1, the blend amount of each of the blending agents is shown as the number of parts by mass thereof for 100 parts by mass of the rubber component in each of the examples).
a) Rubber component

Natural rubber (NR): product “RSS #3”
b) Carbon black (CB)

Carbon black (ISAF): product, “SEAST 6”, manufactured by Tokai Carbon Co., Ltd.
c) Peptizing agents

Peptizing agent (1): product, “NOCTIZER SS”, manufactured by Ouchi Shinko Chemical Industry Co., Ltd.

Peptizing agent (2): product, STRUKTOL HT105, manufactured by a company, Struktol

Peptizing agent (3): product, AKTIPLAST MS, manufactured by a company, Rhein Chemie
d) Dihydrazide compounds

Dihydrazide compound (1): dihydrazideisophthalate (IDH), manufactured by Japan Finechem Co., Inc.

Dihydrazide compound (2): dihydrazide adipate (ADH), manufactured by Japan Finechem Co., Inc.
e) Zinc oxide: product, “AENKA No. 1”, manufactured by Mitsui Mining and Smelting Co., Ltd.
f) Stearic acid: product, “BEADS STEARIC ACID”, manufactured by NOF Corp.
g) Anti-aging agent: product, “ANTIGEN 6C”, manufactured by Sumitomo Chemical Co., Ltd.
h) Vulcanization promoter: Product, “SANCELLER CM-G”, manufactured by Sanshin Chemical Industry Co., Ltd.
i) Sulfur: powdery sulfur, manufactured by Tsurumi Chemical Industry Co., Ltd.

TABLE 1

| | | | | | | | Com- | Com- | Com- | Com- | Com- | Com- | Com- | Com- |
|---|---|---|---|---|---|---|---|---|---|---|---|---|---|---|
| | | | | | | | parative | parative | parative | parative | parative | parative | parative | parative |
| | | | Exam- | Exam- | Exam- | Exam- | Exam- | Exam- | Exam- | Exam- | Exam- | Exam- | Exam- | Exam- |
| | | | ple 1 | ple 2 | ple 3 | ple 4 | ple 1 | ple 2 | ple 3 | ple 4 | ple 5 | ple 6 | ple 7 | ple 8 |
| Step I | Rubber | NR | 100 | 100 | 100 | 100 | 100 | 100 | 100 | 100 | 100 | 100 | — | 100 |
| | master | CB | 30 | 30 | 30 | 30 | 30 | 30 | 30 | 30 | — | — | — | — |
| | batch | Peptizing | 0.3 | — | — | 0.3 | 0.3 | — | 0.3 | — | — | 0.3 | — | 0.3 |
| | | agent (1) | | | | | | | | | | | | |
| | | Peptizing | — | 0.3 | — | — | — | — | — | — | — | — | — | — |
| | | agent (2) | | | | | | | | | | | | |
| | | Peptizing | — | — | 0.3 | — | — | — | — | — | — | — | — | — |
| | | agent (3) | | | | | | | | | | | | |
| | | Dihydrazide | 1 | — | 1 | 0.7 | — | — | — | 1 | 1 | 1 | — | — |
| | | compound (1) | | | | | | | | | | | | |
| | | Dihydrazide | — | 1 | — | — | — | — | — | — | — | — | — | — |
| | | compound (2) | | | | | | | | | | | | |

| | | | | | | | | | | | | | |
|---|---|---|---|---|---|---|---|---|---|---|---|---|---|
| Step II | NR | — | — | — | — | — | — | — | — | — | — | 100 | — |
| | CB | 20 | 20 | 20 | 20 | 20 | 20 | 20 | 20 | 50 | 50 | 50 | 50 |
| | Dihydrazide | — | — | — | 0.3 | — | — | 1 | — | — | — | 1 | 1 |
| | compound (1) | | | | | | | | | | | | |
| | Zinc oxide | 3 | 3 | 3 | 3 | 3 | 3 | 3 | 3 | 3 | 3 | 3 | 3 |
| | Stearic acid | 1 | 1 | 1 | 1 | 1 | 1 | 1 | 1 | 1 | 1 | 1 | 1 |
| | Anti-aging | 1 | 1 | 1 | 1 | 1 | 1 | 1 | 1 | 1 | 1 | 1 | 1 |
| | agent | | | | | | | | | | | | |
| Step III | Vulcanization | 1 | 1 | 1 | 1 | 1 | 1 | 1 | 1 | 1 | 1 | 1 | 1 |
| | promoter | | | | | | | | | | | | |
| | Sulfur | 2 | 2 | 2 | 2 | 2 | 2 | 2 | 2 | 2 | 2 | 2 | 2 |

| | | | | | | | | | | | | |
|---|---|---|---|---|---|---|---|---|---|---|---|---|
| Low thermogenic performance | 45 | 47 | 43 | 48 | 100 | 102 | 66 | 56 | 55 | 65 | 65 | 66 |
| (tanδ) | | | | | | | | | | | | |
| Workability | 99 | 99 | 100 | 101 | 100 | 115 | 136 | 151 | 151 | 135 | 152 | 135 |

From results in Table 1, it is understood that: excellent low thermogenic performance is exhibited by a vulcanized rubber yielded from a rubber composition obtained, using as a raw material a rubber master batch obtained by blending, into a diene rubber, a peptizing agent, a dihydrazide compound and a carbon black simultaneously, and kneading the resultant blend; and further the rubber composition is also excellent in workability.

By contrast, in Comparative Examples 2 and 3, no dihydrazide compound was blended in the production of the rubber master batch thereof; thus, it is understood that the Comparative Examples were poorer than Examples in the low thermogenic performance of their vulcanized rubber, and in the workability of their rubber composition. In Comparative Example 4, no peptizing agent was blended in the production of the rubber master batch thereof; thus, it is understood that the rubber composition was deteriorated in workability, and the low thermogenic performance of the vulcanized rubber was also poorer than that of Examples. In each of Comparative Examples 5 and 6, in which in the production of the rubber master batch the raw material polymer and the hydrazide compound were earlier kneaded and in step II the carbon black was added thereto and the resultant blend was kneaded, it is understood that, identically, the rubber composition was deteriorated in workability, and the low thermogenic performance of the vulcanized rubber was also poorer than that of Examples.

Furthermore, in Comparative Example 8, natural rubber and the peptizing agent were beforehand blended to perform the masticating step, and next the carbon black, the peptizing agent, and/or the dihydrazide compound were substantially simultaneously charged thereinto, and then the resultant blend was kneaded. As a result, it is understood that, identically, the rubber composition was deteriorated in workability, and the low thermogenic performance of the vulcanized rubber was also poorer than that of Examples.

What is claimed is:

1. A method for producing a rubber master batch, comprising: blending, into a diene rubber, 0.1 to 0.5 parts by mass of a peptizing agent, 0.1 to 5.0 parts by mass of a dihydrazide compound, and 10 to 35 parts by mass of a carbon black simultaneously for 100 parts by mass of the diene rubber, and kneading the resultant blend.

2. A method for producing a rubber composition for tire treads, comprising:
step I of producing a rubber master batch by the rubber master batch producing method recited in claim 1,
step II of blending, into the rubber master batch, one or more blending agents different from any vulcanization-related blending agent, and kneading the resultant blend, and
step III of blending, after step II, one or more vulcanization-related blending agents into the blend obtained through step II, and kneading the resultant blend.

3. A rubber composition for tire treads, which is obtained by the producing method recited in claim 2.

4. A pneumatic tire, obtained by use of the rubber composition for tire treads which is recited in claim 3.
